(19) United States
(12) Patent Application Publication
(10) Pub. No.: US 2015/0095284 A1
(43) Pub. Date: Apr. 2, 2015

(54) INFORMATION STORAGE SYSTEM, INFORMATION STORAGE METHOD, AND COMPUTER-READABLE MEDIUM STORING PROGRAM

(71) Applicant: NEC CORPORATION, Tokyo (JP)

(72) Inventor: YUTA NAMIKI, TOKYO (JP)

(21) Appl. No.: 14/494,616

(22) Filed: Sep. 24, 2014

(30) Foreign Application Priority Data
Sep. 27, 2013 (JP) 2013-200873

(51) Int. Cl. G06F 17/30

(52) U.S. Cl. CPC G06F 17/30044
USPC 707/627

(57) ABSTRACT

A data storage unit that stores saving target data including a plurality of attribute values, and data identification information including any one of the attribute values included in the saving target data, as a data pair; and a data structure conversion unit that changes the attribute value included in the data identification information of the data pair stored in the data storage unit, to another one of the attribute values included in the saving target data stored as the data pair, are included. During a period of time that the data structure conversion unit is changing the attribute value included in the data identification information, reference to the data pair, which is the target of the change by the data structure conversion unit, is prohibited.

### INCORPORATION BY REFERENCE

The present invention is based upon and claims the benefit of priority from Japanese patent application No. 2013-200873, filed on Sep. 27, 2013, the disclosure of which is incorporated herein in its entirety by reference.

### TECHNICAL FIELD

The present invention relates to an information storage system, an information storage method, and a computer-readable medium storing a program, and in particular, to an information storage system, an information storage method, and a computer-readable medium storing a program, which include KVS.

### BACKGROUND ART

As a method for storing extremely large quantity of data, distributed key-value store (hereinafter referred to as KVS) has attracted attention.

In general, KVS places importance on scalability and throughput. As such, KVS must represent data in a simple structure consisting of a key and a value (hereinafter referred to as a KV pair). Further, the operation that the KVS is able to support is limited to three types of operation, that is, designating a key of a KV pair to acquire the value, storing a KV pair, and designating a key to delete the KV pair.

As KVS has such characteristics, if a value other than the attribute stored as a key is used as an access path, KVS needs to be routed through an index prepared in advance. As such, when a value other than the attribute stored as a key is used as an access path, KVS must acquire the index first and then analyze the content, and further acquire the real data. Consequently, the time required for acquiring real data increases, when a value other than the attribute stored as a key is used as an access path.

Further, as KVS places importance on scalability, it only supports an atomic operation with respect to one KV pair, generally. As such, when requests from a plurality of clients are processed simultaneously, data inconsistency may occur.

As a method of searching for data stored in KVS at a high speed, Patent Document 1 has been known. Patent Document 1 discloses a method aiming at high-speed processing by splitting a data table into split tables, and storing and processing them.

Further, as a method of reorganizing a storage method in order to realize high-speed search, Patent Document 2 has been known. Patent Document 2 discloses a system for reorganizing a storage method into one corresponding to an access trend by tracing an access path to a database corresponding to a data operation request.
Patent Document 1: JP 2012-164333 A
Patent Document 2: JP 05-002515 A

However, the art disclosed in Patent Document 1 has a problem that a value range may not be narrowed even if splitting is performed depending on the distributed state of the values, whereby it does not necessarily lead to high-speed accessing.

Further, if the art disclosed in Patent Document 2 is applied to KVS, there is a problem that data inconsistency may occur when requests from a plurality of clients are processed simultaneously.

As described above, there is a problem that it is difficult to realize high-speed accessing while preventing data inconsistency in KVS. Therefore, an exemplary object of the present invention is to provide an information storage system having KVS which enables high-speed accessing while preventing data inconsistency.

### SUMMARY

In order to achieve the exemplary object, an information storage system, which is an aspect of the present invention, is configured to include

a data storage unit that stores saving target data including a plurality of attribute values, and data identification information including any one of the plurality of the attribute values included in the saving target data, as a data pair; and

a data structure conversion unit that changes the attribute value included in the data identification information of the data pair stored in the data storage unit, to another one of the attribute values included in the saving target data stored as the data pair, wherein

during a period of time that the data structure conversion unit is changing the attribute value included in the data identification information, reference to the data pair, which is the target of the change by the data structure conversion unit, is prohibited.

Further, an information storage method, which is another aspect of the present invention, is configured to include, by an information processing device in which saving target data including a plurality of attribute values and data identification information including any one of the plurality of the attribute values included in the saving target data are stored as a data pair,

changing the attribute value included in the data identification information of the data pair, to another one of the attribute values included in the saving target data stored as the data pair; and

during a period of time that the attribute value included in the data identification information is changed, prohibiting reference to the data pair.

Further, a program, which is another aspect of the present invention, is a program for causing an information processing device to realize, the information processing device including a data storage unit that stores saving target data including a plurality of attribute values and data identification information including any one of the plurality of the attribute values included in the saving target data, as a data pair,

a data structure conversion unit that changes the attribute value included in the data identification information of the data pair stored in the data storage unit, to another one of the attribute values included in the saving target data stored as the data pair, wherein

the program allows the information processing device to have a function of prohibiting reference to the data pair, during a period of time that the data structure conversion unit is changing the attribute value included in the data identification information.

With the above-described configuration, the present invention is able to provide an information storage system having KVS which enables high-speed accessing while preventing data inconsistency.

### BRIEF DESCRIPTION OF DRAWINGS

FIG. 1 is a block diagram showing a schematic configuration of an information storage system according to a first exemplary embodiment;

FIG. 2 is a block diagram showing a configuration of an information storage system according to a first exemplary embodiment;

FIG. 3 shows an example of data in KV format stored in the information storage system shown in FIG. 1;

FIG. 4 shows a detailed configuration of user data stored in the key-value store shown in FIG. 2;

FIG. 5 shows a flow of data to be acquired when the information storage system shown in FIG. 1 performs data acquisition processing;

FIG. 6 shows an exemplary flow of data structure conversion processing in the first exemplary embodiment;

FIG. 7 shows a flow of data structure conversion processing in the case where units of main key information are included in an index section in the first exemplary embodiment;

FIG. 8 is a flowchart showing a flow when the information storage system shown in FIG. 1 performs data acquisition processing;

FIG. 9 is a flowchart showing a flow when a data structure conversion device shown in FIG. 2 changes key information;

FIG. 10 is a flowchart showing processing of data accessing from a client device during data structure conversion by the data structure conversion device shown in FIG. 2;

FIG. 11 is a flowchart showing a flow of data structure conversion processing according to a second exemplary embodiment;

FIG. 12 is a block diagram showing a schematic configuration of an information storage system according to a third exemplary embodiment; and

FIG. 13 is a block diagram showing a schematic configuration of an information storage system according to a fourth exemplary embodiment.

### EXEMPLARY EMBODIMENTS

### First Exemplary Embodiment

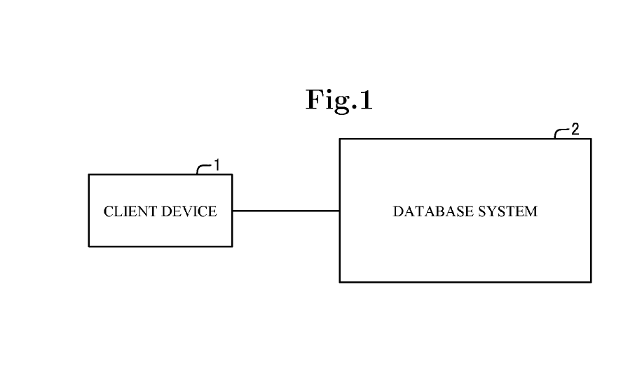

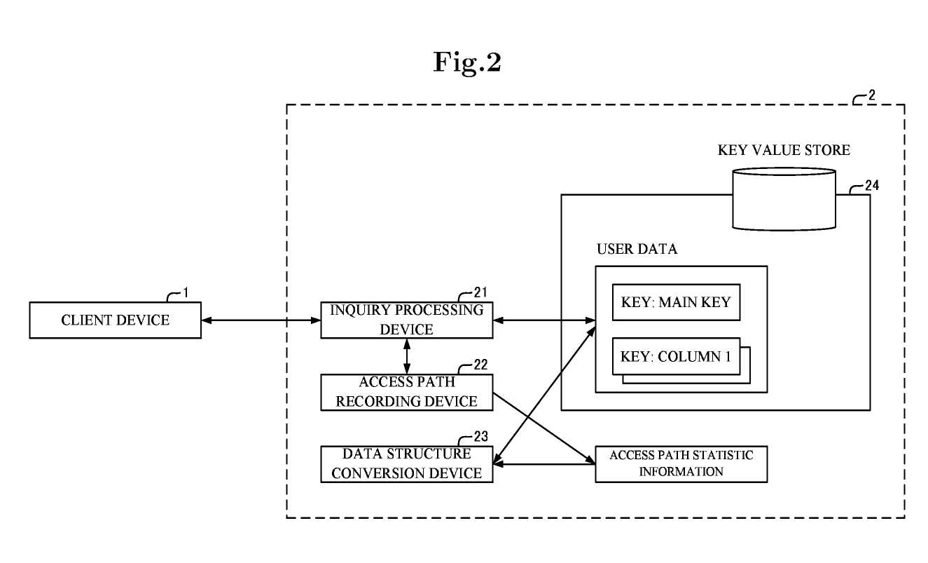

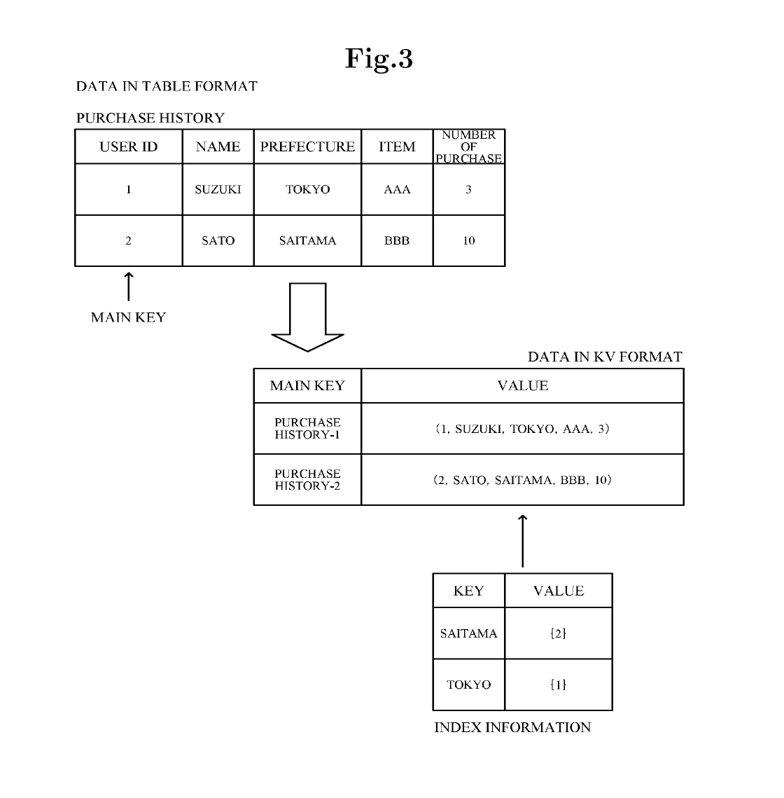

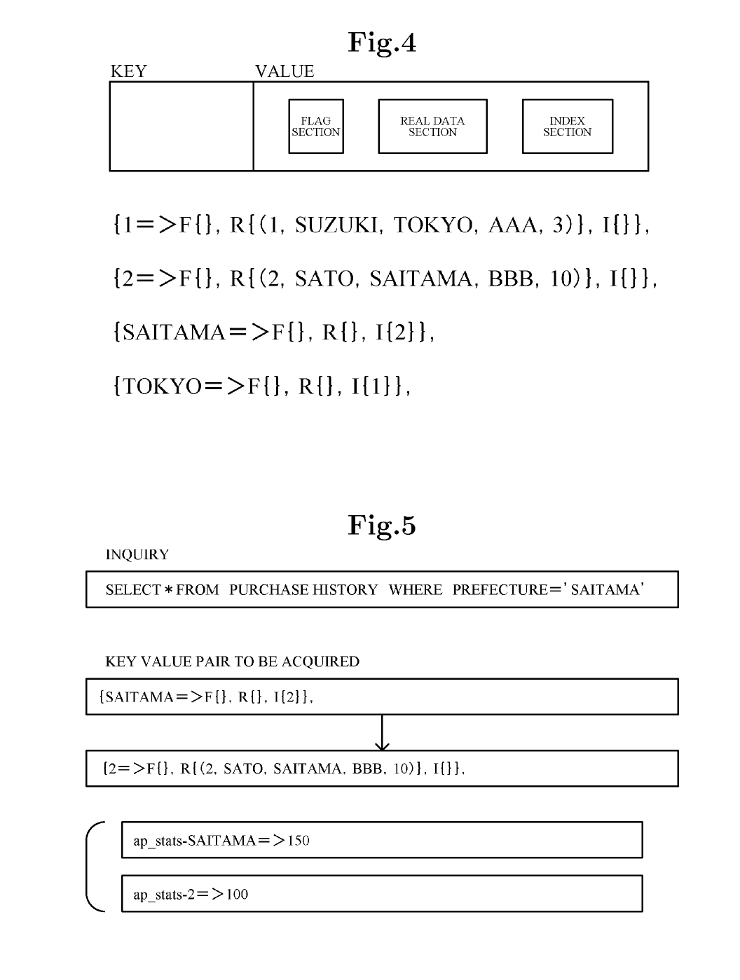

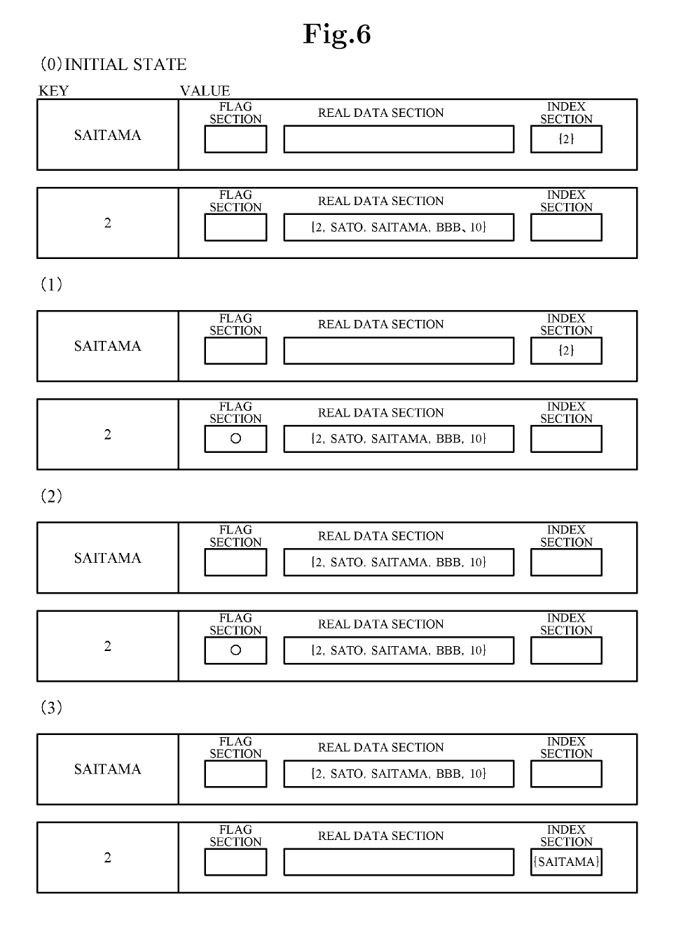

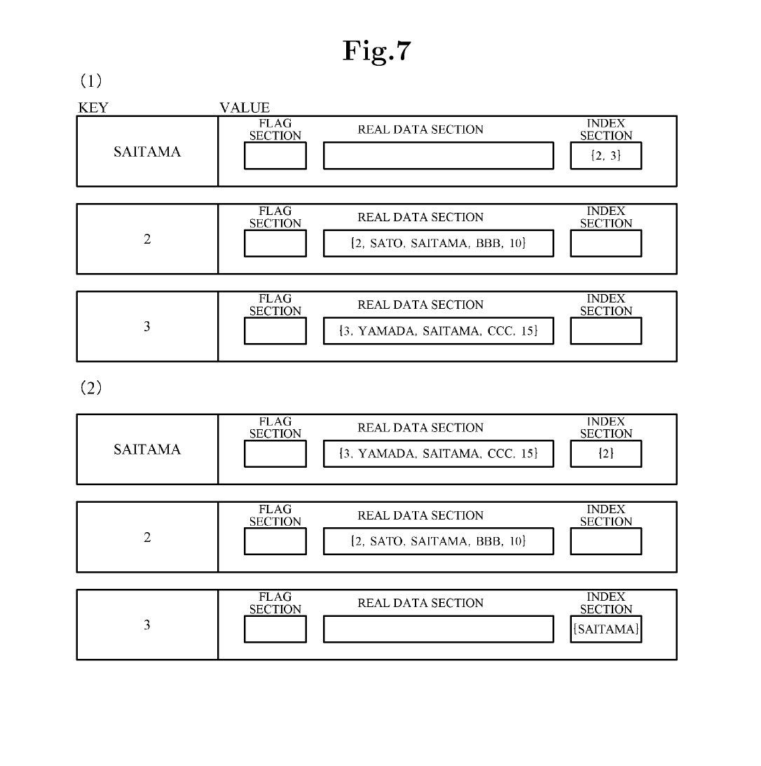

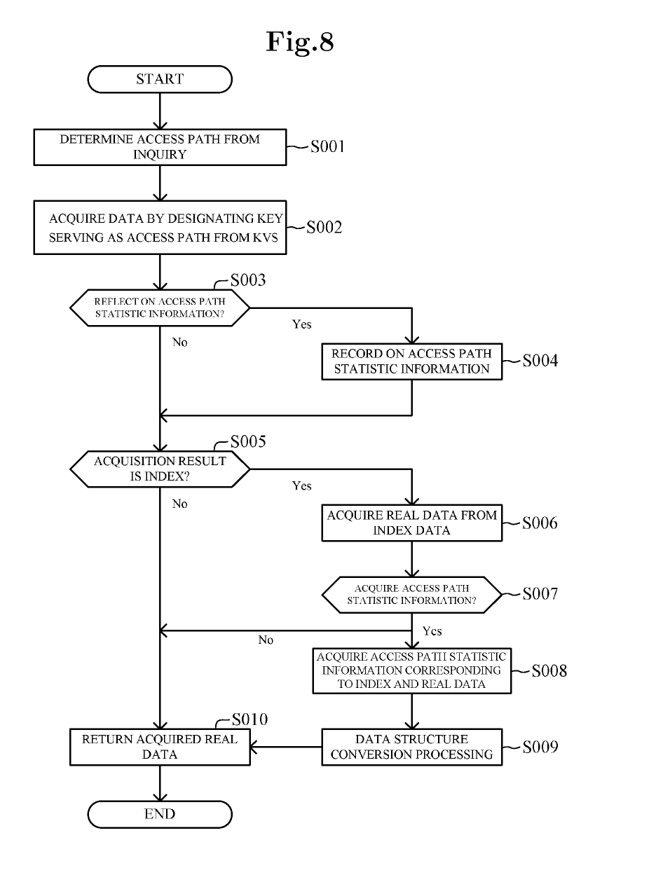

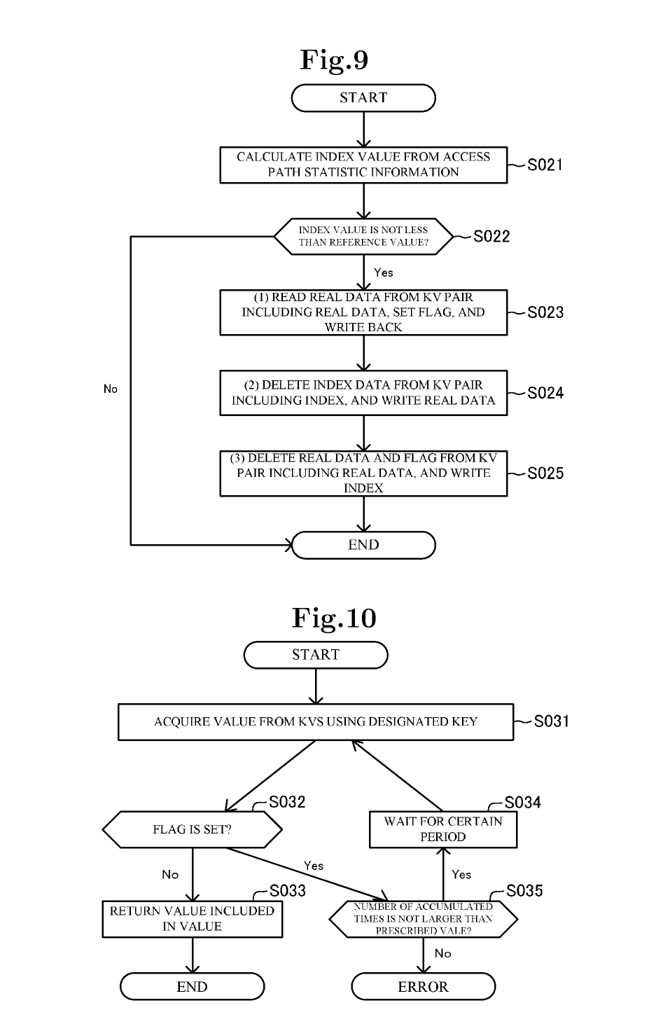

A first exemplary embodiment of the present invention will be described with use of FIGS. 1 to 10. FIG. 1 is a block diagram showing a schematic configuration of an information storage system. FIG. 2 is a block diagram showing a configuration of the information storage system. FIG. 3 shows an example of data in KV format stored in the information storage system. FIG. 4 shows a detailed configuration of user data stored in the key-value store. FIG. 5 shows an exemplary flow of data to be acquired when the information storage system performs data acquisition processing. FIG. 6 shows an exemplary change in the data structure when the data structure conversion processing changes key information. FIG. 7 shows an exemplary change in the data structure of a KV pair in which units of main key information are included in an index section. FIG. 8 is a flowchart showing a flow when the information storage system performs data acquisition processing. FIG. 9 is a flowchart showing a flow when the data structure conversion device changes key information. FIG. 10 is a flowchart showing processing of data accessing from a client device during data structure conversion by the data structure conversion device shown in FIG. 2.

In the first exemplary embodiment of the present invention, an information storage system equipped with a key-value store (KVS) storing key information (data identification information), which is identification information for accessing data, and saving target data to be saved, as a pair of units of data.

### (Configuration)

As shown in FIG. 1, the information storage system of the first exemplary embodiment is configured to include a client device 1 and a database system 2. The client device 1 and the database system 2 are connected with each other so as to be able to transmit and receive information with each other.

The client device 1 is a device which issues an inquiry to the database system 2. Specifically, the client device 1 issues an inquiry for data acquisition or the like to the database system 2. Further, the client device 1 receives a reply to an inquiry, from the database system 2. The client device 1 may be a typical information processing device including an operation unit and a memory unit, such as a personal computer, for example.

The database system 2 is a system which performs storing of data, and the like. Upon receipt of an inquiry from the client device 1, the database system 2 performs acquisition, storage, deletion, or the like of data. As shown in FIG. 2, the database system 2 includes an inquiry processing device 21, an access path recording device 22 (retrieval attribute value information storage processing unit), a data structure conversion device 23 (data structure conversion unit), and a key-value store 24 (hereinafter referred to as KVS 24) (data storage unit).

It should be noted that the present embodiment is based on a premise that each of the devices is an independent information processing device having an operation unit and a memory unit not shown. Further, the functions of each of the information processing devices are performed such that the operation unit, provided to each of the devices, executes programs installed in the each of the devices. However, the present invention may be realized by one or a plurality of information processing devices having the functions of the respective devices. Further, the KVS 24 of the present invention may be configured of one server or a plurality of servers.

Here, user data stored in the database system 2 (KVS 24) of the present embodiment will be described with reference to FIGS. 3 and 4. As shown in FIG. 3, the database system 2 (KVS 24) stores data in table format as data in key-value format (hereinafter referred to as KV format). Data in KV format is data in a format in which saving target data (value) to be saved and key information (data identification information) serving as identification information for retrieving the saving target data are stored as a data pair (KV pair, key-value pair). The database system 2 (KVS 24) accesses the saving target data stored in the database system 2 (KVS 24) based on the key information. It should be noted that the key information, forming a pair with the saving target data, in which data is contained in a real data section described below, is particularly used as main key information.

Further, as shown in FIG. 4, the saving target data (value) of the present embodiment is configured to include a flag section, a real data section, and an index section. The flag section is a portion used in the case of processing of data accessing from the client device 1 during data structure conversion described below. As described below, by using the flag section, the database system 2 is able to change the data structure while preventing occurrence of data inconsistency. The real data section is a portion for saving real data to be saved, which is configured of one or a plurality of attribute values. The index section is a portion used in the case of forming index information described below. Further, the main key information is determined from any one value (if the attribute value of the real data section is only one, the one value) of a plurality of attribute values included in the real data section of the saving target data stored as a pair with the key information.

It should be noted that while, in the present embodiment, the saving target data (values) is configured to include the flag section, the real data section, and the index section, it is not necessary to divide the values into three parts when embodying the present invention. It is only necessary to distinguish, in any form, the three types of data to be stored in the flag section, the real data section, and the index section.

Further, the database system 2 (KVS 24) according to the present embodiment is able to access the stored saving target data only via the key information, due to its characteristics. As such, it is necessary to use index information in order to access the saving target data by using the attribute values except for the attribute value used as the main key information, among the attribute values constituting (the real data section or the index section of) the saving target data.

As shown in FIGS. 3 and 4, the index information is a data pair (KV pair) consisting of key information formed of attribute values except for the attribute used as the may key information, and the saving target data in which the main key information is stored in the index section, among the attribute values constituting the saving target data. As the database system 2 (KVS 24) stores the index information, (the inquiry processing device 21 of) the database system 2 is able to acquire the saving target data in which the real data is saved, via the index information.

As an example of data in KV format as described above, FIG. 3 shows user data representing purchase history. As shown in FIG. 3, the user data exemplary described in the present embodiment is one in which data in table format, including user ID, name, prefecture, item, and purchase quantity shown as respective attributes, is represented as data in KV format. Further, in the data in KV format of the present embodiment, a user ID is used as main key information. Specifically, the database system 2 (KVS 24) of the present embodiment stores data in KV format in which the attribute values of the user ID, name, prefecture, item, and purchase quantity, constituting the real data, are 1, Suzuki, Tokyo, AAA, and 3, respectively, and “1” which is the value of the user ID is used as main key information. Further, the database system 2 (KVS 24) stores data in KV format in which the values of the attributes are 2, Sato, Saitama, BBB, and 10, respectively, and “2” which is the value of the user ID is used as main key information. Further, the database system 2 stores index information in which Saitama, which is one attribute value of the saving target information, and “2” which is the main key information of the saving target data having Saitama as a value, are associated. Further, the database system 2 stores index information in which Tokyo, which is one attribute value of the saving target information, and “1” which is the main key information of the saving target data having Tokyo as a value, are associated.

This means that if a KV pair consisting of the key information and the storage target data is expressed as a form of “key=>value”, as shown in FIG. 4, the database system 2 (KVS 24) stores respective units of data expressed as

### “{1=>F{ }, R{(1, Suzuki, Tokyo, AAA, 3)}, I{ }},”

### “{2=>F{ }, R{(2, Sato, Saitama, BBB, 10)}, I{ }},”

### “{Saitama=>F{ }, R{ }, I{1}},”

### “{Tokyo=>F{ }, R{ }, I{1}},”

It should be noted that the flag section, the real data section, and the index section are abbreviated as F, R, and I, respectively. Intrinsically, as a value of key information, not only the attribute value (“2”) but also the name of the table and the name of the attribute must be included (e.g., “purchase history-user ID-2”) in order that the key information becomes unique. However, as it is redundant, only an attribute value is simply used in the description of the present invention.

The user data to be stored in the database system 2 (KVS 24) in the present embodiment is as described above. Hereinafter, respective configurations of the present embodiment will be described in detail with use of the user data which has been exemplary described above.

First, the inquiry processing device 21 will be described. The inquiry processing device 21 accepts an inquiry of data acquisition or the like from the client device 1, and performs data acquisition or the like from the KVS 24. Further, the inquiry processing device 21 returns a result of the inquiry from the client device 1, to the client device 1. The inquiry processing device 21 also performs exchanges regarding access path statistic information (retrieval attribute information) with the access path recording device 22 and the data structure conversion device 23 described below.

Specifically, when the inquiry processing device 21 accepts an inquiry from the client device 1, the inquiry processing device 21 analyzes it and determines an access path through which data (KV pair) is acquired from the KVS 24. Here, an access path means key information for accessing the saving target data (KV pair) saved in the KVS 24. Then, the inquiry processing device 21 notifies the KVS 24 of the determined access path. As a result of notification of the access path to the KVS 24, the inquiry processing device 21 acquires a KV pair from the KVS 24. Then, the inquiry processing device 21 transmits the acquired data to the client device 1. If the acquired KV pair is index information, the inquiry processing device 21 makes an inquiry again to the KVS 24.

Specifically, in the case of expressing data acquisition by using SQL (Structured Query Language) which is a typical inquiry language to the database, the inquiry processing device 21 acquires a KV pair from the KVS 24 with the following inquiry:

“SELECT*FROM purchase history WHERE user ID=2”

Further, the inquiry processing device 21 also acquires a KV pair from the KVS 24 with the inquiry shown below. In the case of this inquiry, the inquiry processing device 21 accesses the saving target data including real data via the index information.

“SELECT*FROM purchase history WHERE prefecture=‘Saitama’”

It should be noted that the inquiry processing device 21 may be configured not to transmit the real data represented by the acquired KV pair to the client device 1 in a predetermined case, when the inquiry processing device 21 acquired the KV pair from the KVS 24. This operation is realized by referring to the flag section of the acquired KV pair by the inquiry processing device 21. Specifically, the inquiry processing device 21 is configured not to transmit the acquired real data to the client device 1, if a flag is set in the flag section of the acquired KV pair. This operation of the inquiry processing device 21 will be described in detail below.

Further, when the inquiry processing device 21 determines an access path in response to an inquiry from the client device 1 and acquires a KV pair from the KVS 24, the inquiry processing device 21 instructs the access path recording device 22 to keep a record of using the access path (access path statistic information, retrieval attribute information). However, there may be a case where the inquiry is a temporal inquiry and it is better not to affect the access path statistic information, for example. Accordingly, the inquiry processing device 21 may be configured not to make an instruction to the access path recording device 22 in a predetermined condition. This can be realized by configuring the inquiry processing device 21 not to make an instruction to the access path recording device 22 if a comment in particular format is included as shown below, for example.

“SELECT*FROM purchase history WHERE user ID=2/*exemption*/”

It should be noted that the inquiry processing device 21 may be configured to make an instruction for updating the access path statistic information only when a comment in particular format is included.

Further, when making an access via the index (for example, when acquiring saving target data (KV pair) in which data is stored in the index section from the KVS 24), the inquiry processing device 21 acquires access path statistic information (retrieval attribute information), described below, from the access path recording device 22 at arbitrary frequency (once in every ten times of accessing via the index). This means that when the inquiry processing device 21 makes an access via the index, the inquiry processing device 21 acquires a KV pair from the KVS 24 at arbitrary frequency, and also acquires access path statistic information from the access path recording device 22. Specifically, the inquiry processing device 21 acquires access path statistic information corresponding to the index and the real data. Then, the inquiry processing device 21 transmits the data, acquired from the KVS 24, to the client device 1, and also transmits the acquired access path statistic information to the data structure conversion device 23. It should be noted that the inquiry processing device 21 may be configured not to acquire the access path statistic information. This is realized by configuring the inquiry processing device 21 to instruct the access path recording device 22 to transmit access path statistic information to the data structure conversion device 23.

FIG. 5 shows an example of inquiry and data (KV pair) acquisition by the inquiry processing device 21 as described above. As shown in FIG. 5, the inquiry processing device 21 makes an inquiry to the KVS 24 as shown below, for example.

“SELECT*FROM purchase history WHERE prefecture=‘Saitama’”

Then, the inquiry processing device 21 acquires a KV pair as shown below from the KVS 24.

“{Saitama=>F{ }, R{ }, I{2}},”

Then, the inquiry processing device 21 analyzes the acquired KV pair, and acquires the main key information “2” from the index section. Then, the inquiry processing device 21 makes an inquiry to the KVS 24 again with the acquired value “2”, and acquires the following KV pair from the KVS 24:

“{2=>F{ }, R{(2, Sato, Saitama, BBB, 10)}, I{ }},”

Thereby, the inquiry processing device 21 is able to acquire real data from “Saitama” which is the value of a prefecture which is an attribute other than the main key information.

At this time, the inquiry processing device 21 acquires access path statistic information (retrieval attribute information) as shown below, for example, from the access path recording device 22 at arbitrary frequency. Specifically, the inquiry processing device 21 acquires access path statistic information corresponding to the access path, used when acquiring the above-described KV pair, from the access path recording device 22.

“{ap_stats-Saitama=>150}”

“{ap_stats-2=>100}”

Here, “ap_stats” represents an access path statistic information identifier. Further, “150” and “100” represent the number of times that the respective access paths have been used. As such, the access path statistic information described above represent information that the number of times that “Saitama” is used as an access path is 150, and the number of times that “2” is used as an access path is 100.

Then, the inquiry processing device 21 transmits the acquired real data to the client device 1, and also transmits the acquired access path statistic information to the data structure conversion device 23. The configuration of the inquiry processing device 21 is as described above.

Next, the access path recording device 22 will be described. The access path recording device 22 is a device which stores access path statistic information.

Specifically, when the access path recording device 22 is instructed to leave a record (access path statistic information, retrieval attribute value information) that an access path is used from the inquiry processing device 21, the access path recording device 22 stores a record that the access path is used as access path statistic information. Here, access path statistic information is information expressed as “{ap_stats-Saitama=>150}” or the like, as described above. As such, when the access path recording device 22 is instructed from the inquiry processing device 21, the access path recording device 22 stores that the number of times that the access path was used is incremented by one (that is, “Saitama” has been used as the access path 151 times), that is, “{ap_stats-Saitama=>151}”, for example. Thereby, the access path recording device 22 is able to leave the number of times that the access path was used as a record. It should be noted that if the inquiry processing device 21 used a new access path, the access path recording device 22 generates new access path statistic information corresponding to the access path, and stores the number of times that it was used as one.

Further, when the access path recording device 22 is instructed by the inquiry processing device 21, the access path recording device 22 transmits access path statistic information corresponding to the instruction to the inquiry processing device 21. Thereby, data structure conversion processing, described below, can be performed.

It should be noted that in the present embodiment, it has been described that the access path recording device 22 stores access path statistic information in KV format. However, the present embodiment is not limited to the case where the access path statistic information is stored in KV format. It is only necessary that the access path recording device 22 can leave a record that an access path was used in any way. Further, in the case where the access path statistic information is stored in KV format, the access path statistic information may be stored in the same server as that used as the KVS 24, or stored in a server other than the KVS 24.

Further, the instruction to store the access path statistic information, provided to the access path recording device 22, is performed in the stage where the inquiry processing device 21 receives an inquiry from the client device 1 and determines the access path (or in the stage where the access path is determined from the inquiry and the KV pair is acquired from the KVS), as described above. As such, if the KV pair acquired from the KVS 24 by the inquiry processing device 21 is index information, when an inquiry is made to the KVS 24 by the inquiry processing device 21 based on the index information, the access path recording device 22 does not update the access path statistic information. The configuration of the access path recording device 22 is as described above.

Next, the data structure conversion device 23 will be described. The data structure conversion device 23 is a device which performs data structure conversion processing. Here, data structure conversion processing means processing to change an attribute, serving as main key information, to another attribute. Further, data structure conversion processing also means updating index information along with a change of the main key information. Accordingly, the data structure conversion device 23 is a device which rewrites main key information to another attribute and updates index information.

Specifically, the data structure conversion device 23 first receives access path statistic information from the inquiry processing device 21. Then, the data structure conversion device 23 calculates an index value (conversion index value) from the given access path statistic information. Then, the data structure conversion device 23 compares the calculated index value with a predetermined threshold to thereby determine whether or not to perform data structure conversion processing.

Here, calculation of an index value by the data structure conversion device 23 is performed using the following equation:

“index value=the number of accesses via index/the number of accesses not via index”

In the case shown in FIG. 5, the number of accesses using “Saitama” as an access path via the index is 150. Further, the number of accesses using “2” as an access path not via the index is 100. As such, in the case shown in FIG. 5, the index value is 1.5.

Further, the above-described equation means that if the index value is 1 or larger, the number of accesses via the index is larger than the number of accesses not via the index. As such, by setting 1 to the threshold stored in the data structure conversion device 23, it is possible to configure the data structure conversion device 23 so as to change the access path to an attribute having a larger number of accesses if the number of accesses via the index is larger than the number of accesses not via the index.

It should be noted that in the case of the above-described equation, by setting the threshold to be larger than 1, it is possible to configure the data structure conversion device 23 to perform data structure conversion processing only when the number of accesses via the index is sufficiently larger than the number of accesses not via the index. By adjusting the threshold in this way, it is possible to adjust the determination of the data structure conversion processing by the data structure conversion device 23. Accordingly, the threshold in the present invention is not limited to 1, and an arbitrary threshold may be set. Further, the way of calculating the index value is not limited to the case of using the above-described equation, and the index value is not necessarily calculated. It is only necessary that the data structure conversion device 23 is configured such that the data structure conversion device 23 can determine whether or not to perform data structure conversion processing based on the access path statistic information

Here, the details of the data structure conversion processing performed by the data structure conversion device 23 will be described with use of FIG. 6.

First, as shown in (0) in FIG. 6, before data structure conversion processing is performed by the data structure conversion device 23, it is assumed that a KV pair, as shown below, is stored in the KVS 24.

“{Saitama=>F{ }, R{ }, I{2}},”

“{2=>F{ }, R{(2, Sato, Saitama, BBB, 10)}, I{ }},”

Here, it is assumed that as the number of retrievals using “Saitama” as an access path (via the index) is larger than the number of retrievals using “2” which is the main key information, the data structure conversion device 23 determines to perform data structure conversion processing. In that case, the data structure conversion device 23 performs data structure conversion processing to change the main key information from “2” to “Saitama”.

In this case, the data structure conversion device 23 first acquires a KV pair containing the following real data, from the KVS 24:

“{2=>F{ }, R{(2, Sato, Saitama, BBB, 10)}, I{ }},”

Then, the data structure conversion device 23 reads the target data stored in the real data section and temporarily stores it. At the same time as reading the real data, the data structure conversion device 23 sets a flag in the flag section. Then, the data structure conversion device 23 writes back the KV pair, in which the flag is set, to the KVS 24. Consequently, the following KV pair is stored in the KVS 24 ((1) in FIG. 6):

“{2=>F{∘}, R{(2, Sato, Saitama, BBB, 10)}, I{ }},”

Next, the data structure conversion device 23 acquires a KV pair (target of data structure conversion processing) containing the index as described below, from the KVS 24:

“{Saitama=>F{ }, R{ }, I{2}},”

Then, the data structure conversion device 23 writes the real data read from the KV pair containing the real data described above, into the real data section of the newly acquired KV pair. Further, the data structure conversion device 23 deletes the data stored in the index section of the newly acquired KV pair. Then, the data structure conversion device 23 writes back the following KV pair, which is the result thereof, to the KVS 24 ((2) in FIG. 6):

“{Saitama=>F{∘}, R{(2, Sato, Saitama, BBB, 10)}, I{ }},”

Then, the data structure conversion device 23 acquires the KV pair in which the real data has been stored originally and a flag is first set in the flag section, as shown below, from the KVS 24.

“{2=>F{∘}, R{(2, Sato, Saitama, BBB, 10)}, I{ }},”

Then, the data structure conversion device 23 deletes the real data stored in the real data section. Further, the data structure conversion device 23 stores reference to the KV pair, in which the real data is newly written as described above, in the index section (writes a value of a new attribute of the main key information in the index section). Then, the data structure conversion device 23 releases the flag, and writes the following KV pair back to the KVS 24:

“{2=>F{ }, R{ }, I{Saitama}},”

As described above, as the data structure conversion device 23 performs data structure conversion processing, the KVS 24 stores the data as shown below ((3) in FIG. 6):

“{Saitama=>F{ }, R{(2, Sato, Saitama, BBB, 10)}, I{ }},”

“{2=>F{ }, R{ }, I{Saitama} },”

This means that the main key information of the KV pair, stored in the KVS 24, is changed to “Saitama”. Further, when the inquiry processing device 21 performs extraction by using the value “2”, it is performed via the index. The configuration of the data structure conversion device 23 is as described above.

Next, the KVS 24 will be described. As described above, the KVS 24 is a server which stores data in key value format. The KVS 24 is formed of one or a plurality of servers. As the details of data to be stored in the KVS 24 have been described above, the description thereof is omitted.

In general, as KVS places importance on scalability, operation that the KVS is able to support is only acquiring a value by designating the key of a KV pair (get), storing the KV pair (put), and deleting the KV pair by designating the key (delete).

Accordingly, the KVS 24 is able to perform the above-described processing such as storing of data, in accordance with an instruction from the inquiry processing device 21. The KVS 24 is also able to perform the above-described processing such as storing of data, in accordance with an instruction from the data structure conversion device 23. However, as described above, the KVS 24 is not able to perform operation other than the acquisition, storing, and deletion of data. As such, during the data structure conversion processing by the data structure conversion device 23, a client, who does not recognize that the data structure is under conversion, may update the KV pair, for example.

For example, it is assumed that after the target data stored in the real data section has been read in the data structure conversion processing by the data structure conversion device 23, during the time that the real data is deleted from the real data section of the KV pair and index information is written in the index section, the following data is written:

“{2=>F{ }, R{(2, Sato, Saitama, BBB, 99)}, I{ }},”

In this case, although the data is updated normally, the updated data will be deleted in the data structure conversion processing to be performed subsequently by the data structure conversion device 23 (see (3) in FIG. 6). Further, as it is update after the data structure conversion device 23 has read the real data from the real data section, the updated data is not reflected on the real data forming a pair with “Saitama” which becomes new main key information by the data structure conversion processing. As such, even though data update succeeded, as the real data in which the key information is “Saitama” is referred to, only the data before the update can be referred to.

In order to prevent such a problem, the flag section, described above, is used in the present embodiment. Specifically, as described above, the inquiry processing device 21 is configured such that, if a flag is set in the acquired KV pair, the inquiry processing device 21 does not transmit real data represented by the KV data to the client device 1.

With this configuration, if a flag is not set in the acquired KV pair, the inquiry processing device 21 transmits the real data included in the KV pair to the client device 1. On the other hand, if a flag is set in the KV pair, the inquiry processing device 21 refrains from transmitting the real data to the client device 1. Then, after a predetermined time has elapsed, the inquiry processing device 21 reacquires the KV pair from the KVS 24. As a result, if the flag of the reacquired KV pair is released, the inquiry processing device 21 transmits the real data included in the KV pair to the client device 1. On the other hand, if the flag has not been released, the inquiry processing device 21 again refrains from transmitting the real data to the client device 1. Then, after waiting for a predetermined time to be elapsed again, the inquiry processing device 21 reacquires the KV pair. The inquiry processing device 21 repeats this processing until release of the flag is confirmed in principle. However, the inquiry processing device 21 is configured to terminate the processing of acquiring the KV pair as an error, if the number of reacquisition exceeds a prescribed value. With this configuration, it is possible to prevent unintended reference.

The inquiry processing device 21 may be configured not to update the real data of the KV pair if a flag is set in the KV pair. In that case, if a flag is not set in the acquired KV pair, the inquiry processing device 21 updates the real data included in the KV pair (rewrites the real data in the real data section). Then, the inquiry processing device 21 stores the KV pair, in which the real data has been updated, in the KVS 24. On the other hand, if a flag is set in the KV pair, the inquiry processing device 21 refrains from updating the real data. Then, after a predetermined time has elapsed, the inquiry processing device 21 reacquires the KV pair from the KVS 24. As a result, if the flag of the reacquired KV pair is released, the inquiry processing device 21 updates the real data included in the KV pair. On the other hand, if the flag has not been released, the inquiry processing device 21 again refrains from updating the real data. Then, the inquiry processing device 21 waits for elapse of the predetermined time again, and reacquires the KV pair. The inquiry processing device 21 repeats this processing until release of the flag is confirmed in principle. However, the inquiry processing device 21 is configured to terminate the processing of acquiring the KV pair as an error, if the number of reacquisition exceeds a prescribed value. With this configuration, it is possible to prevent unintended data update.

It should be noted that in the present embodiment, both data reference and data update are prohibited during the time that a flag is set. However, the inquiry processing device 21 may be configured such that only data update is prohibited. This is realized by configuring the inquiry processing device 21 so as to check the flag section only when it attempts to update data.

Further, the invention in the present embodiment works effectively in the case where the index section of one KV pair refers to a plurality of units of real data (main key data). In that case, data structure conversion processing by the data structure conversion device 23, described above, will be performed for each reference (main key information) of the index section.

For example, the case where one index section refers to two units of main key information will be described using FIG. 7.

As shown in (1) of FIG. 7, it is assumed that a KV pair, as shown below, has been stored in the KVS 24 before the data structure conversion processing is performed by the data structure conversion device 23.

“{Saitama=>F{ }, R{ }, I{2, 3}},”

“{2=>F{ }, R{(2, Sato, Saitama, BBB, 10)}, I{ }},”

“{3=>F{ }, R{(3, Yamada, Saitama, CCC, 15)}, I{ }},”

As described above, in the case of FIG. 7, the index section forming a pair with “Saitama”, which is the key information, has two kinds of information, that is, user ID “2” and user ID “3”. In this case, the data structure conversion device 23 attempts of convert data structure with respect to the user ID “3”. As the detailed flow of data change is the same as the case described above, the description thereof is omitted.

Then, as a result of data structure conversion processing by the data structure conversion device 23, a KV pair, as described below, is stored in the KVS 24 ((2) of FIG. 7).

“{Saitama=>F{ }, R{(3, Yamada, Saitama, CCC, 15)}, I{2}},”

“{2=>F{ }, R{(2, Sato, Saitama, BBB, 10)}, I{ }},”

“{3=>F{ }, R{ }, I{Saitama}},”

In this way, as a result of data structure conversion processing performed by the data structure conversion device 23, the KV pair in which “Saitama” is the key information includes information of both the real data and the index information. This means that the KV pair in which “Saitama” is the key information is handled as a direct access with respect to the data of the user ID “3”, while handled as an access via the index with respect to the data of the user ID “2”. Then, assuming that data structure conversion processing is also performed on the KV pair of the user ID “2”, the KV pair in which “Saitama” is the main key information becomes a KV pair having real data in two rows in the real data section. In this way, the invention of the present embodiment also works effectively even in the case where the index section of one KV pair refers to a plurality of units of real data (main key information).

The configuration of the information storage system in the present embodiment is as described above. With this configuration, the information storage system is able to include KVS having an access path which can be easily used, while preventing data inconsistency.

Next, operation of the information storage system will be described using FIGS. 8 to 10. First, a flow of data acquisition processing performed by the information storage system will be described using FIG. 8.

### (Operation)

First, the client device 1 issues an inquiry to the database system 2. Then, the inquiry processing device 21 in the database system 2 receives the inquiry issued by the client device 1.

Next, the inquiry processing device 21, which received the inquiry from the client device 1, analyzes the inquiry, and determines an access path which is key information for accessing a KV pair stored in the KVS 24 (S001).

Then, the inquiry processing device 21 acquires a KV pair (data) from the KVS 24 using the determined access path (S002).

Further, at the stage where the inquiry processing device 21 determined the access path based on the inquiry from the client device 1 and acquired the KV pair from the KVS 24 (or at the stage of determining the access path based on the inquiry from the client device 1), the inquiry processing device 21 determines whether or not to instruct the access path recording device 22 to leave a record of using the access path (access path statistic information) (S003).

Determination of whether or not to instruct the access path recording device 22 by the inquiry processing device 21 is made based on whether or not the instruction from the client device 1 includes a comment in a particular format, for example. Specifically, the inquiry processing device 21 does not instruct the access path recording device 22 to update access path statistic information if the instruction from the client device 1 includes a comment in a particular format (S003, No). On the other hand, if the instruction from the client device 1 does not include a comment in a particular format, the inquiry processing device 21 makes an instruction to the access path recording device 22 (S003, Yes).

In the case where the inquiry processing device 21 instructs the access path recording device 22 to update the access path statistic information, the access path recording device 22 receives the instruction. Then, the access path recording device 22 records that the access path was used, in the access path statistic information (S004). Updating of the access path statistic information by the access path recording device 22 is performed by updating the number of use of the access path, for example. Then, the access path recording device 22 notifies the inquiry processing device 21 that the access path statistic information was updated.

On the other hand, in the case where the inquiry processing device 21 does not instruct the access path recording device 22 to update, or after receiving a notice that the access path statistic information was updated from the access path recording device 22, the inquiry processing device 21 determines whether or not the KV pair acquired from the KVS 24 includes index information (S005). It should be noted that the inquiry processing device 21 may be configured to determine whether or not the acquired KV pair includes index information, after making the instruction described above to the access path recording device 22 without waiting for a notice that the instruction has completed.

Determination of whether or not the acquired KV pair includes index information is performed by checking the index section of the acquired KV pair. Specifically, if data is stored in the index section of the KV pair, the inquiry processing device 21 determines that the acquired KV pair includes index information (S005, Yes). In this case, the inquiry processing device 21 reacquires the KV pair (data) from the KVS 24, using the main key information stored in the index section of the KV pair as an access path (S006). Thereby, the inquiry processing device 21 is able to acquire real data from the index data.

Then, the inquiry processing device 21 determines whether or not to acquire access path statistic information from the access path recording device 22, when the real data is accessed via the index (S007). Determination of whether or not to acquire access path statistic information by the inquiry processing device 21 is performed based on the number of accesses performed via the index, for example.

Specifically, the inquiry processing device 21 determines to acquire access path statistic information from the access path recording device 22 once in ten times of accesses via the index, for example (S007, Yes). In this case, the inquiry processing device 21 makes an inquiry to the access path recording device 22, and acquires access path statistic information corresponding to the index and the real data from the access path recording device 22 (S008). Then, the inquiry processing device 21 transmits the acquired access path statistic information to the data structure conversion device 23.

Then, the data structure conversion device 23, which acquired the access path statistic information, performs data structure conversion processing based on the access path statistic information (S009). It should be noted that the detailed flow of the data structure conversion processing performed by the data structure conversion device 23 will be described below.

On the other hand, if the KV pair acquired from the KVS 24 by the inquiry processing device 21 does not include index information (S005, No), the inquiry processing device 21 returns the real data represented by the acquired KV pair to the client device 1 (S010). If the inquiry processing device 21 does not acquire access path statistic information by acquiring the real data via the index (S007, No), or after the data structure conversion processing by the data structure conversion device 23 ends, the inquiry processing device 21 returns the acquired real data to the client device 1, similarly. The inquiry processing device 21 may be configured such that even in this case, the inquiry processing device 21 transmits the real data to the client device at the stage where it acquires the real data via the index, without waiting for completion of the data structure conversion processing by the data structure conversion device 23.

Through the flow described above, the information storage system performs processing of data acquisition. Next, a flow when the data structure conversion device 23 changes the main key information (flow of data structure conversion processing) will be described using FIG. 9.

As described above, the data structure conversion device 23 receives the access path statistic information from the inquiry processing device 21. Then, the data structure conversion device 23 calculates an index value (conversion index value) using the acquired access path statistic information (S021).

Then, the data structure conversion device 23 compares the calculated index value with a threshold predetermined for the data structure conversion device 23 to thereby determine whether or not the index value is a reference value or larger (S022).

If the index value is smaller than the threshold (S022, No), the data structure conversion device 23 does not perform data structure conversion processing, and ends the processing (S022).

Meanwhile, if the index value is the threshold or larger (S022, Yes), the data structure conversion device 23 performs data structure conversion processing.

Specifically, the data structure conversion device 23 first acquires a KV pair including real data, from the KVS 24. Then, the data structure conversion device 23 reads the real data (target data) stored in the real data section, from the acquired KV pair. At the same time as readout of the real data, the data structure conversion device 23 sets a flag in the flag section. Then, the data structure conversion device 23 writes back the KV pair, in which the flag is set, to the KVS 24 (S023).

Next, the data structure conversion device 23 acquires a KV pair including index information, from the KVS 24. Then, the data structure conversion device 23 writes the real data, read out at S023, into the real data section of the KV pair including the acquired index information. Further, the data structure conversion device 23 deletes the data stored in the index section of the KV pair including the acquired index information. Then, the data structure conversion device 23 writes back the KV pair, in which the real data was written and the data in the index section was deleted, to the KVS 24.

Then, the data structure conversion device 23 reacquires the KV pair in which the flag was set, having been written back to the KVS 24 at S023, from the KVS 24. Then, the data structure conversion device 23 deletes the real data stored in the real data section of the acquired KV pair. Further, the data structure conversion device 23 stores reference to the KV pair in which the real data was written at S024, in the index section of the acquired KV pair (stores the value of an attribute serving as new main key information, in the index section). Then, the data structure conversion device 23 releases the flag, and writes back the KV pair, after the release of the flag, to the KVS 24 (S025).

Then, after this operation, the data structure conversion device 23 ends the data structure conversion processing. By performs data structure conversion processing in this way, the data structure conversion device 23 is able to change the main key information of the KV pair stored in the KVS 24.

Next, a flow of processing performed by the inquiry processing device 21 for preventing occurrence of data inconsistency will be described using FIG. 10. As described above, this operation is necessary for preventing a problem of occurrence of data inconsistency or the like, due to update of data during data structure conversion or the like.

As described above, the inquiry processing device 21 first determines an access path based on the inquiry from the client device 1, and acquires a KV pair from the KVS 24 (S031).

Then, the inquiry processing device 21 checks the flag section of the acquired KV pair to determine whether or not a flag is set in the KV pair (S032).

If a flag is not set in the KV pair (S032, No), the inquiry processing device 21 returns the real data included in the KV pair to the client device 1 (S033).

Meanwhile, if a flag is set in the KV pair (S032, Yes), the inquiry processing device 21 does not return the real data included in the KV pair to the client device 1. Then, during the time that the accumulated number of times is not larger than a prescribed value (S035, Yes), after waiting for a predetermined period of time (S034), the inquiry processing device 21 reacquires the KV pair from the KVS 24 (S031). Then, the inquiry processing device 21 checks the flag section of the reacquired KV pair to determine whether or not a flag is set therein.

This means that the inquiry processing device 21 acquires a KV pair from the KVS 24 at certain intervals, and at the stage where a KV pair in which a flag is released is acquired, the inquiry processing device 21 returns the real data included in the KV pair, in which the flag was released, to the client device 1. As such, the inquiry processing device 21 repeats reacquisition of a KV pair until it acquires a KV pair in which a flag was released from the KVS 24 in principle. However, if the accumulated number of times of acquiring a KV pair from the KVS 24 exceeds the predetermined reference value (S035, No), the inquiry processing device 21 performs processing by handling it as an error. Then, the inquiry processing device 21 ends the processing of acquiring a KV pair from the KVS 24 (S035).

Further, the processing performed for preventing data inconsistency, as shown in FIG. 10, is also performed when updating data in the previous stage of the update processing. Specifically, data update is performed by acquiring a KV pair from the KVS 24 by the inquiry processing device 21, and rewriting the real data section of the acquired KV pair by the inquiry processing device 21. As such, the inquiry processing device 21 performs the above-described processing at the stage of acquiring the KV pair from the KVS 24. Then, if a flag is not set in the KV pair, the inquiry processing device 21 rewrites the real data section.

The flow of processing for preventing data inconsistency performed by the inquiry processing device 21 is as described above. With this operation, the data structure conversion device 23 is able to prevent occurrence of data inconsistency, when performing data structure conversion processing.

As described above, the information storage system of the present embodiment includes the access path recording device 22 and the data structure conversion device 23. With this configuration, the information storage system is able to perform data structure conversion processing based on the access path statistic information stored in the access path recording device 22. Consequently, the information storage system is able to change an access path, having a higher access frequency, from an access via the index to a direct access, and further, it is possible to improve the access performance. Although the time for acquiring one KV pair is very small such as a millisecond time scale, as the number of data becomes one million or one billion, the effect becomes extremely large.

Further, the KV pair stored in the KVS of the present embodiment has a flag section. As the KV pair is configured in this way, the information storage system is able to set a flag in the KV pair during the data structure conversion processing. Consequently, the information storage system is able to prevent referring to a KV pair which is the target of the data structure conversion processing during the data structure conversion processing, whereby occurrence of data inconsistency can be prevented.

### Second Exemplary Embodiment

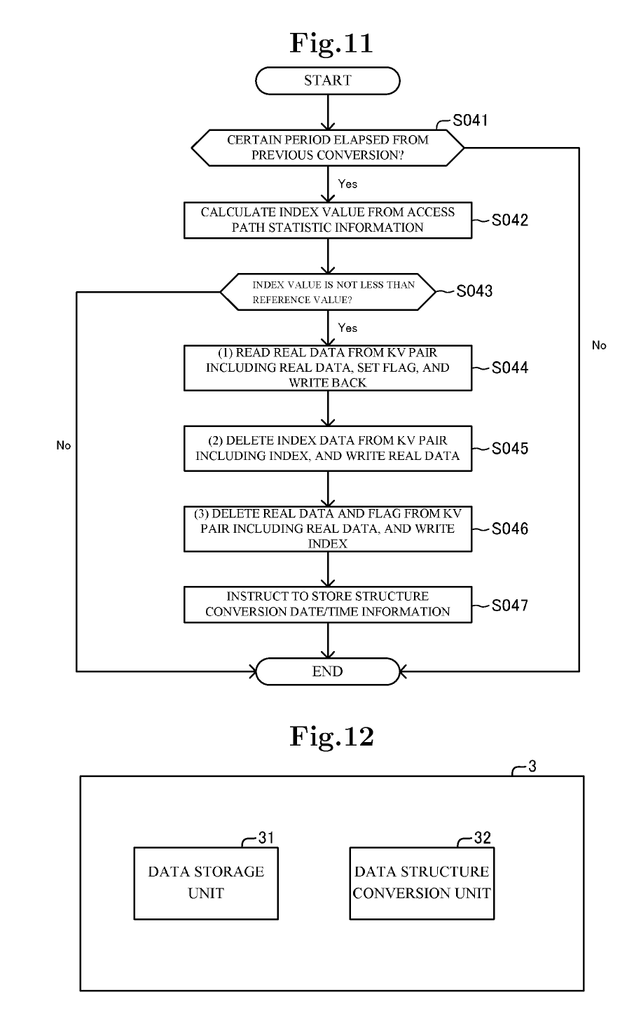

Next, a second exemplary embodiment of the present invention will be described using FIG. 11. FIG. 11 is a flowchart showing a flow of data structure conversion processing in the present embodiment.

### (Configuration)

An information storage system according to the present embodiment includes an almost similar configuration to that of the first exemplary embodiment. This means that the information storage system includes the client device 1 and the database system 2. Further, the database system 2 includes the inquiry processing device 21, the access path recording device 22, the data structure conversion device 23, and the KVS 24. The configurations of these devices are almost similar to those of the first exemplary embodiment. As such, description of the configurations similar to those of the first exemplary embodiment is omitted.

Hereinafter, characteristic part of the present embodiment will be described. The present embodiment is characterized in access path statistic information to be stored in the access path recording device 22. As such, description focuses on the part.

The access path statistic information according to the present embodiment stores a record of use of an access path (access path statistic information, retrieval attribute information), similar to the first exemplary embodiment. The access path statistic information according to the present embodiment is configured to be able to record the date and time that the access path is used as structure conversion time/data information, in addition to a record of use of the access path.

As such, the access path recording device 22 and the data structure conversion device 23 of the present embodiment are configured such that when the data structure conversion device 23 performs data structure conversion processing, the date and time that the data structure conversion processing is performed can be stored in the access path statistic information stored in the access path recording device 22.

Specifically, after the data structure conversion processing, the data structure conversion device 23 instructs the access path recording device 22 to store the structure conversion date/time information in the access path statistic information corresponding to the data structure conversion processing. Upon receipt of the instruction, the access path recording device 22 stores the structure conversion date/time information which is information about the date and time when the data structure conversion processing is performed, in the access path statistic information.

Further, the data structure conversion device 23 of the present embodiment is configured to check the structure conversion date/time information and date/time information showing the current date and time that the data structure conversion processing is going to be performed, before performing data structure conversion processing. If the data structure conversion device 23 determines that the current date and time, when the data structure conversion processing is going to be performed, is not the time that a predetermined period of time has elapsed from the data and time shown by the structure conversion date/time information, the data structure conversion device 23 determines not to perform data structure conversion processing. Meanwhile, if the data structure conversion device 23 determines that the current date and time, when the data structure conversion processing is going to be performed, is the time that a predetermined period of time has elapsed from the date and time shown by the structure conversion date/time information, the data structure conversion device 23 begins calculation of an index value from the access path statistic information. As the data structure conversion device 23 is configured as described above, it is possible to prevent frequent conversion of the data structure.

It should be noted that the date and time, which is stored as the structure conversion date/time information, may be checked by the data structure conversion device 23, or by the access path recording device 22.

Further, an instruction to store the structure conversion date/time information, given by the data structure conversion device 23 to the access path recording device 22, may be performed via the inquiry processing device 21. In that case, after the data structure conversion device 23 transmits information about the structure conversion date/time information to the inquiry processing device 21, the inquiry processing device 21 instructs the access path recording device 22 to store the structure conversion date/time information.

The configuration of the information storage system according to the present embodiment is as described above. Next, a flow when the data structure conversion device 23 changes the main key information (a flow of data structure conversion processing) in the present embodiment will be described using FIG. 11.

First, the data structure conversion device 23 acquires access path statistic information from the inquiry processing device 21. Then, the data structure conversion device 23 checks structure conversion date/time information stored in the access path statistic information and data and time information about the current date and time when data structure conversion processing is going to be performed, and determines whether or not a predetermined period of time has elapsed from the previous data structure conversion processing (S041).

Then, if the data structure conversion device 23 determines that a predetermined period of time has not elapsed from the previous data structure conversion processing, based on the structure conversion date/time information and the date and time information (S041, No), the data structure conversion device 23 does not perform data structure conversion processing and ends the processing.

Meanwhile, if the data structure conversion device 23 determines that a predetermined period of time has elapsed from the previous data structure conversion processing, based on the structure conversion date/time information and the date and time information (S041, Yes), the data structure conversion device 23 calculates an index value using the access path statistic information (S042).

Then, after comparing the index value with a threshold, the data structure conversion device 23 performs data structure conversion processing (S043 to S046). The detailed flow of the data structure conversion processing is the same as that shown in the first exemplary embodiment. As such, the detailed flow of the data structure conversion processing is omitted.

Then, if the data structure conversion device 23 performs the data structure conversion processing, the data structure conversion device 23 instructs the access path recording device 22 to store the date and time that the data structure conversion processing was performed as structure conversion date/time information (S047).

As the data structure conversion device 23 performs the data structure conversion processing in this way, it is possible to prevent frequent change of the data structure. It should be noted that in the present embodiment, data structure conversion device 23 checks the structure conversion date/time information in the first stage of the data structure conversion processing. However, the data structure conversion device 23 may check the structure conversion date/time information after calculating an index value from the access path statistic information, or after comparing the index value with a threshold, for example.

As described above, in the information storage system of the present embodiment, access path statistic information includes structure conversion date/time information. With this configuration, the information storage system is able to perform data structure conversion processing after checking the date and time that the data structure conversion processing was performed and the date and time that data structure conversion processing is going to be performed currently. Consequently, the information storage system can be configured not to perform data structure conversion processing if a certain period of time has not elapsed from the previous data structure conversion processing. Thereby, it is possible to prevent frequent conversion of the data structure.

### Third Exemplary Embodiment

Next, a third exemplary embodiment of the present invention will be described using FIG. 12. FIG. 12 is a block diagram showing a schematic configuration of an information storage system according to the present embodiment.

### (Configuration)

In the third exemplary embodiment, an information storage system, in which data is stored in KV format, will be described. It should be noted that the present embodiment describes the outline of the information storage system.

As shown in FIG. 12, an information storage system 3 of the present embodiment includes a data storage unit 31 and a data structure conversion unit 32.

The data storage unit 31 is a part which stores saving target data consisting of a plurality of attributes, and data identification information consisting of any one of the attributes constituting the storage target data, as a data pair. The information storage system 3 of the present embodiment is configured such that saving target data, to be saved, is stored in the data storage unit 31, and that the saving target data stored in the data storage unit 31 is retrieved using data identification information.

The data structure conversion unit 32 is a part configured to change the attribute constituting the data identification information, of a data pair stored in the data storage unit 31, to another attribute constituting the saving target data stored as the data pair. With the data structure conversion unit 32, the information storage system 3 is able to change the data identification information.

Further, the information storage system 3 of the present embodiment is configured to be able to prohibit reference to a data pair which is the target of a change by the data structure conversion unit 32, during the time that the data structure conversion unit 32 is changing the attribute constituting the data identification information.

Further, the information storage system 3 of the present embodiment is configured to be able to prohibit update of a data pair which is the target of a change by the data structure conversion unit 32, during the time that the data structure conversion unit 32 is changing the attribute constituting the data identification information.

As described above, the information storage system 3 of the present embodiment includes the data storage unit 31 and the data structure conversion unit 32. Further, the information storage system 3 of the present embodiment is configured to be able to prohibit reference and update of a data pair which is the target of a change by the data structure conversion unit 32, during the time that the data structure conversion unit 32 is changing the attribute constituting the data identification information. With this configuration, the information storage system 3 of the present embodiment is able to change the data identification information, and is also able to prohibit reference and update of data which is the target of a change, during the time that the data identification information is being changed. Consequently, the information storage system 3 of the present embodiment is able to change the data identification information while preventing data inconsistency due to a change of the data identification information.

It should be noted that an information storage method, performed by the information storage system described above, is an information storage method including, in an information processing device in which saving target data consisting of a plurality of attribute values and data identification information consisting of any one of the plurality of the attribute values constituting the saving target data are stored as a data pair, changing the attribute value serving as the data identification information of the data pair, to another one of the attribute values constituting the saving target data stored as the data pair; and during a period of time that the attribute value serving as the data identification information is changed, prohibiting reference to the data pair. As the information storage method exhibits the same advantageous effect as that of the information storage system described above, the object of the present invention can be achieved.

Further, the same advantageous effect as that of the information storage system described above can be exhibited by incorporating, in an information processing device including a data storage unit that stores saving target data consisting of a plurality of attribute values and data identification information consisting of any one of the plurality of the attribute values constituting the saving target data are stored as a data pair, a program for causing the information processing device to realize a data structure conversion unit that changes the attribute value serving as the data identification information of the data pair stored in the data storage unit, to another one of the attribute values constituting the saving target data stored as the data pair, and allowing the information processing device to have a function of prohibiting reference to the data pair, which is the target of the change by the data structure conversion unit, during a period of time that the data structure conversion unit is changing the attribute value serving as the data identification information. As such, the object of the present invention can also be achieved.

Even the information storage method and the program, having the above-described configuration, have the same effects as those of the information storage system described above, it is possible to achieve the object of the present invention described above.

### Fourth Exemplary Embodiment

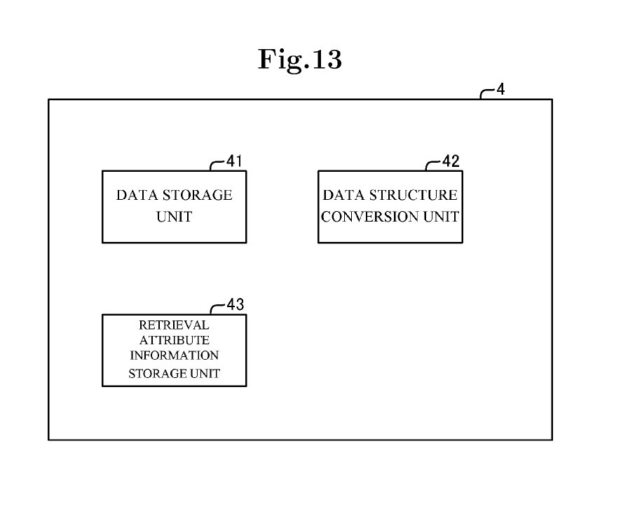

Next, a fourth exemplary embodiment of the present invention will be described using FIG. 13. FIG. 13 is a block diagram showing a schematic configuration of an information storage system according to the present embodiment.

### (Configuration)

In the fourth exemplary embodiment, an information storage system in which data is stored in KV format will be described. It should be noted that in the present embodiment, the outline of the information storage system will be described.

As shown in FIG. 13, an information storage system 4 of the present embodiment includes a data storage unit 41, a data structure conversion unit 42, and a retrieval attribute information storage unit 43. The information storage system 4 also includes a data retrieval unit not shown. It should be noted that the configuration of the data storage unit 41 is the same as the configuration of the data storage unit 31 described in the third exemplary embodiment. As such, the detailed description of the data storage unit 41 is omitted. Further, the data structure conversion unit 42 includes the same configuration as the configuration of the data structure conversion unit 32 described in the third exemplary embodiment. As such, regarding the same part as that of the data structure conversion unit 32, description of the data structure conversion unit 42 is omitted.

The retrieval attribute information storage unit 43 is a part which stores a retrieval attribute, which is used when the data retrieval unit retrieves saving target data from the data storage unit and is one of the attributes constituting the saving target data, as retrieval attribute information, in association with the saving target data retrieved using the retrieval attribute.

Further, the data structure conversion unit 42 of the present embodiment is configured to change the attribute serving as the data identification information, based on the retrieval attribute information stored in the retrieval attribute information storage unit.

As described above, the information storage system 4 of the present embodiment includes the data storage unit 41, the data structure conversion unit 42, and the retrieval attribute information storage unit 43. With this configuration, the information storage system 4 of the present embodiment is able to change the data identification information, based on the retrieval attribute information. Consequently, the information storage system 4 of the present embodiment is able to change the data structure to a structure suitable for data identification information which is easier to be used.

### <Supplementary Notes>

The whole or part of the exemplary embodiments disclosed above can be described as, but not limited to, the following supplementary notes. Hereinafter, the outline of the information storage system and the like according to the present invention will be described. However, the present invention is not limited to the configurations described below.

### (Supplementary Note 1)

An information storage system comprising:

a data storage unit that stores saving target data including a plurality of attribute values, and data identification information including any one of the plurality of the attribute values included in the saving target data, as a data pair; and

a data structure conversion unit that changes the attribute value included in the data identification information of the data pair stored in the data storage unit, to another one of the attribute values included in the saving target data stored as the data pair, wherein

during a period of time that the data structure conversion unit is changing the attribute value included in the data identification information, reference to the data pair, which is a target of a change by the data structure conversion unit, is prohibited.

According to this configuration, the information storage system includes a data storage unit and a data structure conversion unit. Further, the information storage system is configured to prohibit reference to the data pair which is a target of the change by the data structure conversion unit, during the time that the data structure conversion unit is changing the attribute value included in the data identification information. With this configuration, the information storage system is able to change the data identification information. Further, the information storage system is able to prohibit reference to the data which is the target of the change, during the time of changing the data identification information. Consequently, the information storage system is able to change the data identification information while preventing data inconsistency due to a change of the data identification information.

### (Supplementary Note 2)

The information storage system according to supplementary note 1, wherein

during the period of time that the data structure conversion unit is changing the attribute value included in the data identification information, update of the data pair, which is a target of a change by the data structure conversion unit, is prohibited.

According to this configuration, the information storage system is configured to prohibit update of the data pair, which is a target of a change by the data structure conversion unit, during the time that the data structure conversion unit is changing the attribute value included in the data identification information. With this configuration, the information storage system is able to prohibit update of the data which is the target of the change, during the time of changing the data identification information. Consequently, the information storage system is able to change the data identification information while preventing data inconsistency due to a change of the data identification information more reliably.

### (Supplementary Note 3)

The information storage system according to supplementary note 1 or 2, further comprising

a retrieval attribute value information storing unit that stores a retrieval attribute value as retrieval attribute value information, the retrieval attribute value being one of the attribute values included in the saving target data and being used for retrieving the saving target data from the data storage unit, wherein

the data structure conversion unit changes the attribute value included in the data identification information, based on the retrieval attribute value information stored in the retrieval attribute value information storing unit.

According to this configuration, the information storage system includes a retrieval attribute value information storing unit, in addition to the data storage unit and the data structure conversion unit. With this configuration, the data structure conversion unit is able to change the data identification information based on the retrieval attribute information. Consequently, the data structure conversion unit is able to change the data structure to a structure which is suitable for data identification information and easier to be used.

### (Supplementary Note 4)

The information storage system according to supplementary note 3, wherein

the data structure conversion unit calculates a conversion index value based on the retrieval attribute value information, and if the conversion index value exceeds a predetermined threshold, the data structure conversion unit changes the attribute value included in the data identification information.

According to this configuration, the data structure conversion unit is configured to calculate a conversion index value based on the retrieval attribute information, and if the conversion index value exceeds a predetermined threshold, the data structure conversion unit changes the attribute value included in the data identification information. With this configuration, the data structure conversion unit is able to change the data identification information if the conversion index value exceeds the threshold. Consequently, the data structure conversion unit is able to change the data structure to a structure which is suitable for data identification information and easier to be used.

### (Supplementary Note 5)

The information storage system according to supplementary note 4, wherein

the retrieval attribute value information storing unit stores, while including in the retrieval attribute value information, the number of times that the saving target data is retrieved with use of the retrieval attribute value which is the data identification information, and the number of times that the saving target data is retrieved with use of another retrieval attribute value which is not the data identification information, for each of the retrieval attribute values.

According to this configuration, the retrieval attribute value information storing unit stores, as retrieval attribute information, the number of times that the saving target data is retrieved with use of the retrieval attribute which is the data identification information, and the number of times that the saving target data is retrieved with use of another retrieval attribute which is not the data identification information, for each of the retrieval attribute values in association with the saving target data. With this configuration, the data structure conversion unit is able to change the data identification information based on the number of times that the saving target data is retrieved with use of the retrieval attribute which is the data identification information, and the number of times that the saving target data is retrieved with use of another retrieval attribute which is not the data identification information. Consequently, the data structure conversion unit is able to change the data structure to a structure which is suitable for data identification information and easier to be used.

### (Supplementary Note 6)

The information storage system according to supplementary note 5, wherein

the data structure conversion unit calculates a proportion of the number of times that the saving target data is retrieved with use of the retrieval attribute value which is not the data identification information, to the number of times that the saving target data is retrieved with use of the retrieval attribute value which is the data identification information, as the conversion index value, and if the proportion indicated by the conversion index value exceeds the threshold, the data structure conversion unit changes the attribute value included in the data identification information to the retrieval attribute value which is not the data identification information and is used for retrieving the saving target data.

### (Supplementary Note 7)

An information storage method, the method being performed by an information processing device in which saving target data including a plurality of attribute values and data identification information including any one of the plurality of the attribute values included in the saving target data are stored as a data pair, the method comprising:

changing the attribute value included in the data identification information of the data pair, to another one of the attribute values included in the saving target data stored as the data pair; and

during a period of time that the attribute value included in the data identification information is changed, prohibiting reference to the data pair.

### (Supplementary Note 8)

The information storage method according to supplementary note 7, further comprising:

storing a retrieval attribute value as retrieval attribute value information, the retrieval attribute value being one of the attribute values included in the saving target data and being used for retrieving the saving target data; and

changing the attribute value included in the data identification information, based on the retrieval attribute value information.

### (Supplementary Note 9)

A non-transitory computer readable medium storing a program comprising instructions for causing an information processing device to realize, the information processing device including a data storage unit that stores saving target data including a plurality of attribute values and data identification information including any one of the plurality of the attribute values included in the saving target data, as a data pair,

a data structure conversion unit that changes the attribute value included in the data identification information of the data pair stored in the data storage unit, to another one of the attribute values included in the saving target data stored as the data pair, wherein

the program allows the information processing device to have a function of prohibiting reference to the data pair, during a period of time that the data structure conversion unit is changing the attribute value included in the data identification information.

### (Supplementary Note 10)

The non-transitory computer readable medium storing the program according to supplementary note 9, further causing the information processing device to realize

a retrieval attribute value information storing unit that stores a retrieval attribute value as retrieval attribute value information, the retrieval attribute value being one of the attribute values included in the saving target data and being used for retrieving the saving target data from the data storage unit, wherein

the data structure conversion unit has a function of changing the attribute value included in the data identification information, based on the retrieval attribute value information stored in the retrieval attribute value information storing unit.

It should be noted that the program described in the embodiments and the supplementary notes described above is provided by being stored on a storage device or a computer-readable storage medium. The store medium is a portable medium such as a flexible disk, an optical disk, a magneto-optical disk, a semiconductor memory, or the like, for example.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE NUMERALS

1 client device
2 database system
21 inquiry processing device
22 access path recording device
23 data structure conversion device
24 key-value store (KVS)
3 information storage system
31 data storage unit
32 data structure conversion unit
4 information storage system
41 data storage unit
42 data structure conversion unit
43 retrieval attribute information storage unit

1. An information storage system comprising:
a data storage unit that stores saving target data including a plurality of attribute values, and data identification information including any one of the plurality of the attribute values included in the saving target data, as a data pair; and
a data structure conversion unit that changes the attribute value included in the data identification information of the data pair stored in the data storage unit, to another one of the attribute values included in the saving target data stored as the data pair, wherein
during a period of time that the data structure conversion unit is changing the attribute value included in the data identification information, reference to the data pair, which is a target of a change by the data structure conversion unit, is prohibited.

2. The information storage system according to claim 1, wherein
during the period of time that the data structure conversion unit is changing the attribute value included in the data identification information, update of the data pair, which is a target of a change by the data structure conversion unit, is prohibited.

3. The information storage system according to claim 1, further comprising
a retrieval attribute value information storing unit that stores a retrieval attribute value as retrieval attribute value information, the retrieval attribute value being one of the attribute values included in the saving target data and being used for retrieving the saving target data from the data storage unit, wherein
the data structure conversion unit changes the attribute value included in the data identification information, based on the retrieval attribute value information stored in the retrieval attribute value information storing unit.

4. The information storage system according to claim 3, wherein
the data structure conversion unit calculates a conversion index value based on the retrieval attribute value information, and if the conversion index value exceeds a predetermined threshold, the data structure conversion unit changes the attribute value included in the data identification information.

5. The information storage system according to claim 4, wherein
the retrieval attribute value information storing unit stores, while including in the retrieval attribute value information, the number of times that the saving target data is retrieved with use of the retrieval attribute value which is the data identification information, and the number of times that the saving target data is retrieved with use of another retrieval attribute value which is not the data identification information, for each of the retrieval attribute values.

6. The information storage system according to claim 5, wherein
the data structure conversion unit calculates a proportion of the number of times that the saving target data is retrieved with use of the retrieval attribute value which is not the data identification information, to the number of times that the saving target data is retrieved with use of the retrieval attribute value which is the data identification information, as the conversion index value, and if the proportion indicated by the conversion index value exceeds the threshold, the data structure conversion unit changes the attribute value included in the data identification information to the retrieval attribute value which is not the data identification information and is used for retrieving the saving target data.

7. An information storage method, the method being performed by an information processing device in which saving target data including a plurality of attribute values and data identification information including any one of the plurality of the attribute values included in the saving target data are stored as a data pair, the method comprising:
changing the attribute value included in the data identification information of the data pair, to another one of the attribute values included in the saving target data stored as the data pair; and
during a period of time that the attribute value included in the data identification information is changed, prohibiting reference to the data pair.

8. The information storage method according to claim 7, further comprising:
storing a retrieval attribute value as retrieval attribute value information, the retrieval attribute value being one of the attribute values included in the saving target data and being used for retrieving the saving target data; and
changing the attribute value included in the data identification information, based on the retrieval attribute value information.

9. A non-transitory computer readable medium storing a program comprising instructions for causing an information processing device to realize, the information processing device including a data storage unit that stores saving target data including a plurality of attribute values and data identification information including any one of the plurality of the attribute values included in the saving target data, as a data pair,
a data structure conversion unit that changes the attribute value included in the data identification information of the data pair stored in the data storage unit, to another one of the attribute values included in the saving target data stored as the data pair, wherein
the program allows the information processing device to have a function of prohibiting reference to the data pair, during a period of time that the data structure conversion unit is changing the attribute value included in the data identification information.

10. The non-transitory computer readable medium storing the program according to claim 9, further causing the information processing device to realize
a retrieval attribute value information storing unit that stores a retrieval attribute value as retrieval attribute value information, the retrieval attribute value being one of the attribute values included in the saving target data and being used for retrieving the saving target data from the data storage unit, wherein
the data structure conversion unit has a function of changing the attribute value included in the data identification information, based on the retrieval attribute value information stored in the retrieval attribute value information storing unit.
